(19) United States
(12) Patent Application Publication
(10) Pub. No.: US 2010/0083907 A1
(43) Pub. Date: Apr. 8, 2010

(54) Mammal nurser and method of use

(76) Inventor: Stacy L. Polk, Hawthorne, CA (US)

Correspondence Address: SANDRA LEE LIPKIN A LAW CORPORATION, P.O.Box 3518, VENTURA, CA, 93006, US

(21) Appl. No.: 12/287,333

(22) Filed: Oct. 7, 2008

(51) Int. Cl. A01K 9/00

(52) U.S. Cl. 119/71

(57) ABSTRACT

A surrogate nurser for mammal infants, such as kittens and puppies or other infants without the ability to nurse from their mother for any reason is described that includes a furry exterior to provide the feel of the mother. Inside the surrogate is a reservoir with a flat bottom that houses a milk substitute that flows through protrusions that align with holes in the surrogate wherein the protrusions are equipped with nipples that allow the infants to suckle. The head of the surrogate includes a simulated heartbeat and in the case of cats, a simulated purring sound. Both the purring sound and the heartbeat are controlled by switches found on the head of the surrogate. The head is removable for easy cleaning of the body of the surrogate without damaging the electronics found in the head.

### BACKGROUND OF THE INVENTION

1. Field of the Invention

The present invention relates generally to the field of animal feeders and more specifically toward a lifelike nurser for mammal infants that have been denied access to the milk of a biological mother.

2. Description of the Prior Art

Often, mammal infants, particularly cats and dogs, become orphaned and unable to feed themselves. These infants cannot eat solid food and rely entirely on their mother's milk for sustenance. When their mother is unavailable to supply the milk because of separation or death, the infants are left on their own. Without intervention, they cannot survive.

Nursers for kittens and puppies have been the subject of prior inventions. Devices crafted to mimic the appearance and external feel (fur) of the mammalian mother have been devised in order to feed the babies. One example is U.S. Pat. No. 5,188,061 to Lombardi. The Lombardi invention includes a device, illustratively, shaped like a cat, covered with fur that has an internal reservoir for the placement therein of a mother's milk substitute wherein the reservoir has a plurality of holes that can be attached to nipples or caps, depending upon whether the nurser is in use or if the reservoir is being stored with the liquid contained therein.

The Lombardi invention, however, can be improved upon in order to enhance the lifelike appearance of the device to the nursing babies. It is the primary objective of the instant invention to improve upon the lifelike appearance of the nurser in order for a more likely successful nursing relationship with the orphaned babies. The more the babies can feel that the surrogate is a live mother, the more likely they are to suckle.

In the case of all mammals, the mother not only has fur, but the mother has a heartbeat that the babies can hear and did indeed hear through the gestational phase. In the case of cats, the mother's purr summons her kittens to her for nursing and is a comforting sound to them. The instant invention seeks to incorporate these two facets of the appearance of a more natural mother into the nurser. Furthermore, structural improvements have been made to the nurser over Lombardi for more easy access to the reservoir containing the mother's milk substitute, for more durability with regard to the kneading done by baby kittens while nursing, and for a more stable orientation when in use.

### SUMMARY OF THE INVENTION

The preferred embodiment of the present invention teaches a surrogate nurser for a mammal infant comprising an exterior body covered in a soft material. The exterior body includes a removable head and a mid-section that has a hollow interior. The hollow interior houses a removable reservoir for the containment therein of a substitute for mother's milk. The reservoir further comprises a flat bottom; a top that is openable to allow for the placement therein of the mother's milk substitute; a rear wall; two sidewalls; and a front wall wherein the front wall further includes a plurality of protrusions that communicate with the reservoir so as to allow the mother's milk substitute to flow between the reservoir and the protrusions. The protrusions have a first open end that connects to the front wall and a second open end that extends through correlating holes found in the mid-section of the exterior body wherein the protrusions can be attached to nipples to allow for suckling or attached to caps that prevent leakage of the mother's milk substitute when not in use. Also included is a mechanical device that simulates the sound of a heartbeat that is housed in the removable head and a switch that activates the mechanical device housed in the removable head.

The above embodiment can be further modified by defining that the surrogate is used to feed kittens wherein the removable head houses a second mechanical device that simulates the sound of a cat purring and a second switch to activate the second mechanical device.

An alternative embodiment defines a method of feeding small infants that are unable to nurse from their mother comprising the steps of first locating the infants and then locating a surrogate nurser. The surrogate nurser further comprises an exterior body covered in a soft material. The exterior body includes a removable head and a mid-section that has a hollow interior. The hollow interior houses a removable reservoir for the containment therein of a substitute for mother's milk. The reservoir further comprises a flat bottom; a top that is openable to allow for the placement therein of the mother's milk substitute; a rear wall; two sidewalls; and a front wall. The front wall further includes a plurality of protrusions that communicate with the reservoir so as to allow the mother's milk substitute to flow between the reservoir and the protrusions. The protrusions have a first open end that connects to the front wall and a second open end that extends through correlating holes found in the mid-section of the exterior body wherein the protrusions can be attached to nipples to allow for suckling or attached to caps that prevent leakage of the mother's milk substitute when not in use. There is also included a mechanical device that simulates the sound of a heartbeat housed in the removable head and a switch that activates the mechanical device housed in the removable head. The infant is then placed at the mid-section of the nurser and the mechanical device is activated to simulate the sound of a heartbeat.

The above embodiment can be further modified by defining that the mammal infants are kittens wherein the removable head of the surrogate that simulates a full-grown cat also houses a second mechanical device that simulates the sound of a cat purring and a second switch to activate the second mechanical device.

### BRIEF DESCRIPTION OF THE DRAWINGS

This invention can better be understood by reference to the drawings, provided for exemplary purposes, and in which:

FIG. 1 is a side perspective view of the invention with the interior portions shown in phantom.

FIG. 2 is taken along line 2-2 in FIG. 1.

FIG. 3 is an exploded view of the invention with the interior portion removed.

### DETAILED DESCRIPTION OF A PREFERRED EMBODIMENT

The instant invention describes an improved animal feeder/nurser that provides mammal animals with a means of nursing from an inanimate surrogate acting as the natural mother. The invention not only provides multiple nursing nipples from which to suckle, but will imitate the natural sounds of the mother as closely as possible. The surrogate includes a simulated heartbeat, and in the case of a cat surrogate, an electronic purring device.

The improved feeder/nurser is made out of a soft fur, which could be acrylic or faux fur, that covers a body that is shaped like a full grown mammal animal, such as a dog or a cat. In the case of a dog, the invention could come in a variety of sizes, depending on the size of the puppies to be fed. The surrogate animal lies on its side in a normal feeding position with an opening running along the spine area of the back. The opening is easily opened and closed through a hook and loop system that cannot be felt or seen after the hook and loop are connected together. Inside the surrogate, through this opening, is found a durable, washable and removable reservoir for liquids.

There is a cavity in the interior of the surrogate that is accessible through the opening. This cavity is lined with a durable foam material in the case of using a cat surrogate so that the surrogate can tolerate the kneading motion made my small kitten paws and claws as they nurse.

The reservoir that houses the nourishing mother's milk substitute is typically made of plastic and formed into a substantially cylindrical shape, save the bottom portion, which is flat for better support while in use and for storage in a refrigerator. There are a number (in this illustration, eight) cylindrical stems formed on the lower half of the front side of the reservoir. The front side is defined as the side that faces the “belly” of the surrogate. These stems protrude through coordinating holes from the main torso of the surrogate. The holes are approximately one-eighth inch to one-quarter inch in diameter. Nipples attach to the stems much like calf feeding bottles. Alternately, nipples can be screwed on like a baby bottle with a screw on the cap. Closure caps are provided for each stem that fit over the stems when the reservoir is in storage to prevent leakage.

It is to be noted that the surrogate's mid-section must be large enough to accommodate the reservoir. Furthermore, the reservoir must be large enough to house sufficient liquid at a level that can feed the mammal babies through the nipples without running out.

The body of the surrogate includes at least one, and two in the case of cat surrogates, sound boxes that are implanted in the head of the surrogate. One of the boxes sounds like a heartbeat, and in the case of a cat surrogate, the second sound box makes a purring sound. Also included in the head are on-off switches that activate each box. These on-off switches protrude between the ears for easy and quick access, yet away from the nursing area of the surrogate.

The surrogate's head is removable providing for safer and easier cleaning of the surrogate. The head will twist/lock into place into the neck of the body. This arrangement makes for greater ease in washing the main torso without damaging the sound boxes found in the head.

Two straps that form a right system comprised of a hook and loop system are housed within the cavity of the surrogate that can be wrapped around the reservoir to keep it in place. This-reduces the opportunity for the reservoir to topple over.

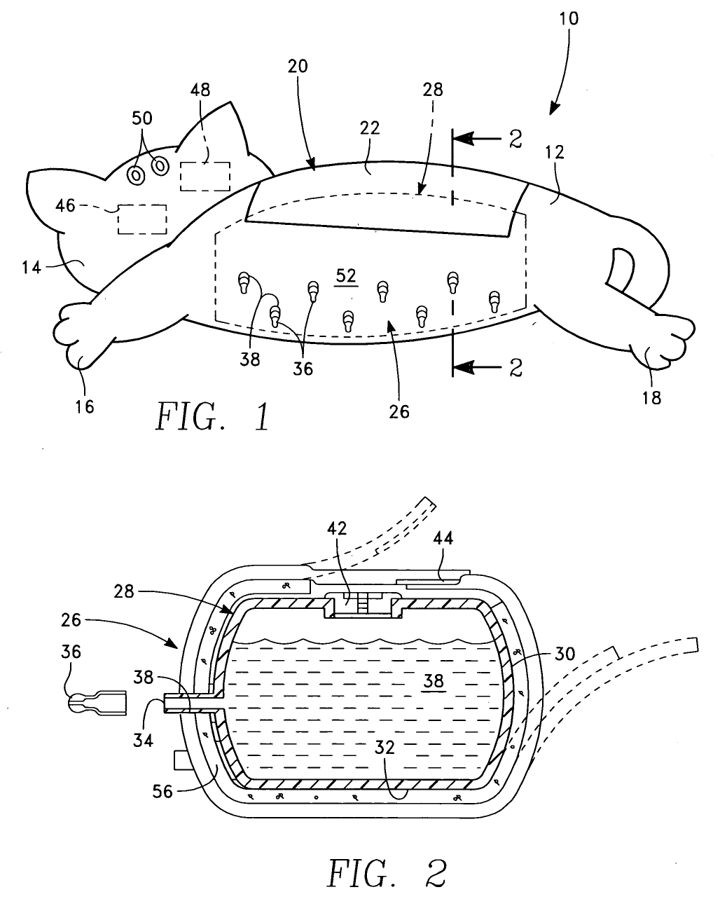

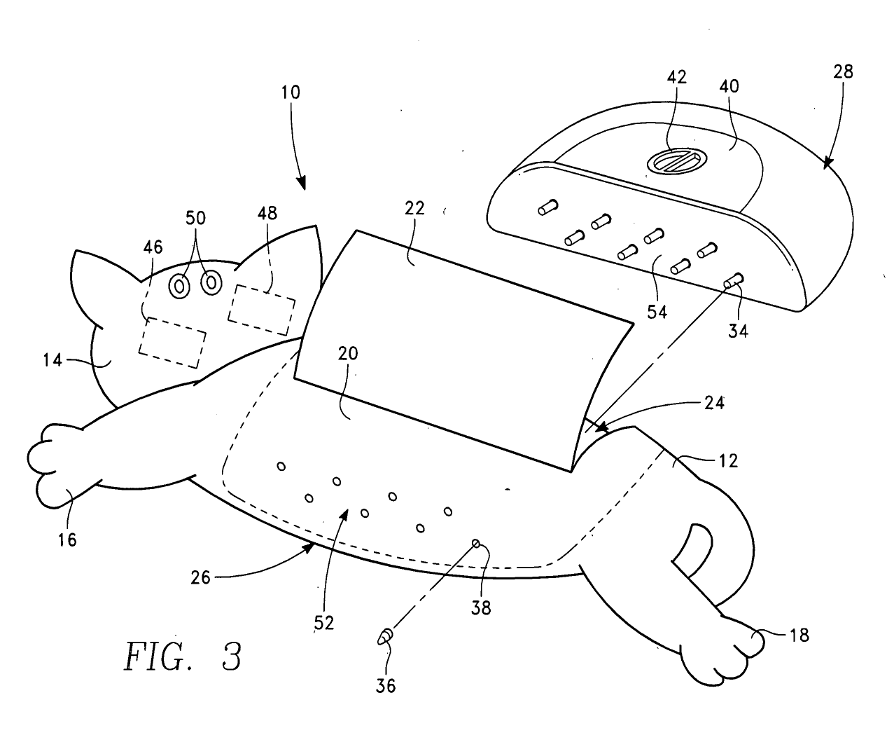

Turning now to the drawings, FIG. 1 shows a side isometric view of the surrogate 10, in this case, a cat. The surrogate 10 has a top side 20, a front side 14, a rear side 18, a bottom side 26 and a mid-portion 52 that is the position at which the kittens (or other mammal infant) will nurse. The surrogate 10 also has a removable head 14. Inside the head 14 is at least one sound box, but in the case of a cat (as illustrated), there are two. First is the heartbeat sound box 46 that is present in all surrogate forms. For cats, there is also a purring sound box 48. Between the two sound boxes are one or more switches 50 that operate the sound boxes. The entire head 14 of the surrogate can be removed so that the remainder of the surrogate can be cleaned without harming the electronics found in the head 14.

The surrogate has an internal chamber 24 that houses the reservoir 28 that contains the milk substitute 38. The reservoir 28 can be seen in detail in FIG. 2. The reservoir 28 has an arcuate shape along its side 30, but has a flat bottom 32 to prevent it from tipping over. The reservoir has a top lid 40 that is openable and closeable with a cap 42. On the front side of the reservoir are a plurality of protrusions 34 that allow for the flow of the milk substitute 38 from the reservoir 28 out of the body of the surrogate 10.

The mid-section 52 of the surrogate 10 contains a plurality of holes 38 that correspond to the protrusions 34 on the reservoir. As illustrated, there are eight protrusions 34 and eight holes 38, but this number could be higher or lower depending on the size surrogate needed and the number of infants to be fed. Screw-on nipples 36 are to be screwed on to the protrusions 34 to allow for nursing therefrom. When not in use, caps (not shown) can be screwed onto the protrusions 34 to prevent leakage. Velcro straps 44 are used to secure the reservoir 28 inside the surrogate 10.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

The discussion included in this patent is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

What is claimed is:

1. A surrogate nurser for a mammal infant comprising
an exterior body covered in a soft material, said exterior body including a removable head and a mid-section that has a hollow interior, said hollow interior housing a removable reservoir for the containment therein of a substitute for mother's milk, said reservoir further comprising
a flat bottom;
a top that is openable to allow for the placement therein of said mother's milk substitute;
a rear wall;
two sidewalls; and
a front wall, said front wall further including a plurality of protrusions that communicate with said reservoir so as to allow said mother's milk substitute to flow between said reservoir and said protrusions, said protrusions having a first open end that connects to said front wall and a second open end that extends through correlating holes found in said mid-section of said exterior body wherein said protrusions can be attached to nipples to allow for suckling or attached to caps that prevent leakage of said mother's milk substitute when not in use;
a mechanical device that simulates the sound of a heartbeat housed in said removable head; and
a switch that activates said mechanical device housed in said removable head.

2. The surrogate nurser as defined in claim 1 wherein said surrogate is used to feed kittens wherein said removable head houses a second mechanical device that simulates the sound of a cat purring and a second switch to activate said second mechanical device.

3. A method of feeding small infants that are unable to nurse from their mother comprising the steps of
locating said infants;
locating a surrogate nurser, said surrogate nurser further comprising
an exterior body covered in a soft material, said exterior body including a removable head and a mid-section that has a hollow interior, said hollow interior housing a removable reservoir for the containment therein of a substitute for mother's milk, said reservoir further comprising
a flat bottom;
a top that is openable to allow for the placement therein of said mother's milk substitute;
a rear wall;
two sidewalls; and
a front wall, said front wall further including a plurality of protrusions that communicate with said reservoir so as to allow said mother's milk substitute to flow between said reservoir and said protrusions, said protrusions having a first open end that connects to said front wall and a second open end that extends through correlating holes found in said mid-section of said exterior body wherein said protrusions can be attached to nipples to allow for suckling or attached to caps that prevent leakage of said mother's milk substitute when not in use;
a mechanical device that simulates the sound of a heartbeat housed in said removable head; and
a switch that activates said mechanical device housed in said removable head;
placing said infant at the mid-section of said nurser; and
activating said mechanical device to simulate thee sound of a heartbeat.

4. The method as defined in claim 3 wherein said mammal infants are kittens wherein said removable head of said surrogate that simulates a full-grown cat also houses a second mechanical device that simulates the sound of a cat purring and a second switch to activate said second mechanical device.
